(19) United States
(12) Patent Application Publication
(10) Pub. No.: US 2011/0013663 A1
(43) Pub. Date: Jan. 20, 2011

(54) THERMAL ANALYSIS METHOD AND APPARATUS

(75) Inventors: Jean-Luc Garden, Echirolles (FR); Jacques Chaussy, Echirolles (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: CENTRE NATIONAL DE LA RECHERCHE SCIENTIFIQUE, PARIS (FR)

(21) Appl. No.: 12/747,798

(22) PCT Filed: Dec. 5, 2008
(86) PCT No.: PCT/FR2008/001700

§ 371 Date: Sep. 30, 2010

(30) Foreign Application Priority Data
Dec. 12, 2007 (FR) 0708660

(51) Int. Cl. G01N 25/48

(52) U.S. Cl. 374/11

(57) ABSTRACT

Thermal analysis method, particularly for determining the heat capacity of body, or its derivative with respect to temperature, or a latent heat, said method comprising differential measurement of a physical parameter between two samples (84, 84′) undergoing a temperature change under equivalent conditions, said method being characterized in that said samples are essentially identical as to composition and thermal properties and exhibit, at the start of the measurement, an initial temperature difference of known magnitude. Apparatus for carrying out such a method.

The invention relates to a thermal analysis method based on differential type measurement.

The invention also relates to apparatus for performing such a method.

In the field of thermal analysis and calorimetry, there exist various ways of proceeding with differential measurements. The oldest is differential thermal analysis (DTA). In that method, two identical cells, one of which contains a sample under investigation, and the other of which contains a reference substance, are subjected to temperature variation over time, typically a ramp (i.e. a linear increase in temperature), under conditions that are identical. The temperature difference between the two cells is measured continuously by one or more thermometers (thermocouples, thermopiles, resistive probes, etc.). If during the ramp, the sample is subjected to a physicochemical transformation, such as a change of phase, or if it presents a change in its heat capacity, the temperature of the cell containing the sample varies in a manner that is different from the temperature of the reference cell. During a ramp, the temperature difference measurement between the two cells is thus representative of a thermal event due to the sample (physicochemical transformation, variation in heat capacity, etc.).

The method that is presently the most widespread, that of differential scanning enthalpy measurement or differential scanning calorimetry (DSC), is derived from the above longstanding method. There are two main varieties. The first is referred to as power compensated differential scanning calorimetry. During the ramp, the two cells are maintained at the same temperature by using two heater elements, each situated in a respective cell. Under such circumstances, the power difference that needs to be delivered via the heater elements (or to be extracted via cooling elements) in order to keep said temperature difference between the two cells equal to zero is measured directly. This power compensated differential measurement is thus directly representative of the physicochemical transformation (including variation in heat capacity) that occurs in the sample during the ramp. The second is referred to as heat flux differential scanning calorimetry. The heat flux difference associated with the temperature difference between the cells is measured without compensation and by means of a thermal element (thermocouple, thermopile). When operating in this way, and like differential thermal analysis, only the temperature difference (more precisely the heat flux difference through the thermo-element(s)) is representative of the physicochemistry of the sample. For an introduction to such techniques, reference may be made to the following works: S. Randzio, Recent developments in calorimetry, Ann. Rep. Prog. Chem. (The Royal Society of Chemistry) sect. C, 94, pp. 433-504 (1998); C. Eyraud and A. Accary, Analyses thermique et calorimétrique différentielles [Differential thermal and calorimetric analyses], Techniques de l'Ingénieur, traité Analyse et Caractérisations, P1295, pp. 1-15 (1992); M. Brun and P. Claudy, Méthodes Thermiques, Microcalorimétrie [Thermal methods, microcalorimetry], Techniques de l'Ingénieur, traitée Analyse et Caractérisations, P1200, pp. 1-23 (1983); and C. B. Murphy, Differential thermal analysis, Anal. Chem., 30, pp. 867-872, 1958.

In addition to the two above conventional thermal analysis methods, there has been an explosion over the last tens of years in novel methods that provide for the use of temperature variations over time of a “non-trivial” type. In those methods, the temperature variations of the two cells are required to follow well-determined functions of time that are selected by the experimenter (sawteeth, oscillations, oscillations superposed on the usual linear ramp. Examples of such techniques are provided by documents U.S. Pat. No. 5,224,775 and U.S. Pat. No. 6,170,984. Those documents refer to the method known as temperature modulated differential scanning enthalpy measurement or as temperature modulated differential scanning calorimetry (TMDSC), in which temperature oscillation is superposed on a linear ramp. Separating the steady and oscillating components of the difference in temperature (or in heat flux when performing differential measurements in heat flux mode) makes it possible to access data having different physical meanings.

Those differential thermal analysis techniques constitute tools that are very powerful for thermally characterizing substances, and applications are to be found in materials science, earth sciences, physics, chemistry, pharmaceutical engineering, and in the agricultural and food industry, etc. Nevertheless they suffer from certain drawbacks.

A first drawback is associated with the fact that, in practice, the sample and the reference substance do not have exactly the same heat capacity. Often, they also present differences in terms of their contact properties with the walls of the measurement cells, and thus with their interface thermal conductances. Furthermore, depending on how the calorimeters are constructed, the heat transfer coefficients between each cell and the thermal bath are never perfectly identical. This leads to systematic errors.

To remedy that drawback, at least in part, it is common practice to subtract a reference curve, known as a “base line”, from the differential measurement, which base line is obtained during an independent measurement performed using the same reference substance in both measurement cells. In theory, that subtraction makes it possible to overcome the effects of the thermal asymmetry of the equipment, which effects ought in practice to occur identically in both measurements and ought therefore to be completely eliminated by subtraction. Nevertheless, in practice, it is impossible for the instantaneous thermal conditions (interference, temperature drifts, electronic drifts, sensor drifts, etc.) to be exactly the same during both of those two different measurements. Consequently, errors remain.

A second drawback is that when the calorimeter system is well designed and its noise level concerning temperature measurement is due solely to the noise of the sensor, the principle of differential measurement does not make it possible to improve measurement resolution, since that is determined by the signal-to-noise ratio of the sensor.

A third drawback is encountered when the physical magnitude of interest is not the magnitude that is provided “directly” by the measurement (e.g. the heat capacity of the sample), but is its derivative relative to temperature. This derivative may be obtained by numerical calculation: however it is well known that any such operation has the effect of amplifying any high frequency noise to which the measurement is subject.

The invention seeks to mitigate, at least in part, at least one of the above-mentioned drawbacks of the prior art.

The principle on which the invention is based consists, during differential measurement, in using two samples that are substantially identical, and that present a known temperature difference, instead of using a sample and a reference. Thus, the interface thermal conditions are identical in both cells and no longer give rise to systematic errors.

In addition, the method acts directly to provide the derivative of the physical magnitude of interest (typically the heat capacity) relative to temperature. There is therefore no longer any need to have recourse to a numerical differentiation operation. If it is heat capacity that is desired, then it is possible to obtain it by numerical integration: this results in a reduction in noise level compared with known techniques of the prior art.

In addition, the initial temperature difference between the two samples provides an additional degree of freedom that enables the user to optimize the measurement method as a function of the physical or physicochemical phenomena that are to be revealed. The signal-to-noise ratio increases with an increase in this temperature difference; however the temperature resolution of the measurement is improved for small temperature differences. Similarly, a fast variation in temperature during the ramp gives rise to a good signal-to-noise ratio but to poor temperature resolution. Thus, a method of the invention provides its user with the possibility of acting on two parameters (initial temperature difference and rate of temperature variation) in order to find an optimum between the contradictory requirements concerning signal-to-noise ratio and temperature resolution, instead of having only one parameter available (rate of temperature variation), as in the prior art.

More precisely, the invention provides a thermal analysis method, the method comprising differential measurement of a physical parameter between two samples that are subjected to temperature variation under equivalent conditions, said method being characterized in that said samples are substantially identical as to their composition and as to their thermal properties, and, at the beginning of measurement, they present an initial temperature difference of known magnitude.

The exact meaning of the term “equivalent conditions” depends on the particular implementation, and in particular on the technique actually used for imposing said temperature variation. Thus, in certain circumstances, the samples follow the same temperature variation, which means that (slightly) different heat powers need to be delivered thereto; in contrast, in other circumstances, they are subjected to the same heat power, and as a result their temperature variations are not necessarily identical; in yet other circumstances, they are coupled in the same manner to a common thermal bath of variable temperature. Under all circumstances, useful information can be extracted specifically because the temperature variation of the two samples is produced under conditions that are as similar as possible, except for the initial temperature difference.

In particular, the differential measurement may serve to determine a thermal property of a sample selected from: the heat capacity of the samples, its derivative relative to temperature, or a latent heat.

In particular implementations of the invention:
The measurement may be performed by differential temperature analysis, the method comprising: measuring variation over time in the temperature difference between said samples; and determining the derivative relative to temperature of the heat capacity of the samples from said variation over time of their temperature difference.
The measurement may be performed by power compensation differential scanning enthalpy measurement, said method comprising: delivering or extracting differential heat power to or from said samples in order to maintain said temperature difference constant throughout the measurement; and determining the derivative relative to temperature of the heat capacity of the samples from said differential heat power.
The measurement may be performed by heat flux scanning differential enthalpy measurement, and comprises: coupling said samples to a thermal bath using the same known heat transfer coefficient; measuring variation over time in the difference between the heat fluxes that flow between each of the samples and said thermal bath; and determining the derivative relative to temperature of the heat capacity of the samples from said variation over time in the difference between the heat fluxes.
Said variation over time in the temperature to which the samples may be subjected is itself obtained, at least in part, by coupling said samples to a thermal bath that is in turn subjected to temperature variation over time.
In a variant or in addition, said variation over time in the temperature to which the samples are subjected may itself be obtained, at least in part, by individual heater or cooling means associated with each sample.
The method may also include a step of numerically integrating the result of said differential measurement in order to determine the heat capacities of said samples in the temperature range within which said measurement was performed.
The variation over time in the temperature to which said samples are subjected may be substantially linear or piecewise linear.
The initial temperature difference between said samples may be less than or equal to one-tenth, and preferably less than or equal to one-hundredth, of the extent of the temperature variation range over which the measurement is performed.

The invention also provides a thermal analysis apparatus for determining a thermal property of a sample, the apparatus comprising a differential calorimeter measurement head and being characterized in that it further comprises control means for controlling said measurement head and for analyzing data obtained by the measurement, the control means being adapted to implement a method as described above.

In particular:
Said differential calorimeter measurement head may be a head for performing differential thermal analysis, and comprises: two receptacles having substantially identical thermal properties, for receiving said samples; means for delivering or extracting heat power to or from said samples; heater or cooling means for differentially heating or cooling said samples so as to impose said initial temperature difference; and measurement means for measuring the instantaneous temperature difference between said samples and for measuring the rate at which the temperature of at least one of said samples varies over time; said control and analysis means comprising: control means for controlling said means for delivering or extracting heat power to or from the samples, and adapted to subject said samples to said temperature variation; and means for calculating said thermal property of the samples from at least knowledge of said initial temperature difference, of the rate at which the temperature of one of the samples varies, and of the instantaneous temperature difference between said samples.
In a variant, said differential calorimeter measurement head may be a head for power compensated differential scanning calorimetry, and comprises: two receptacles having substantially identical thermal properties, for receiving said samples; means for delivering or extracting heat power to or from said samples; and measurement means for measuring the instantaneous temperature of said samples and their temperature difference; said control and analysis means comprising: control means for controlling said means for delivering or extracting heat power to or from the samples, said control means being adapted to subject said samples to said variation over time of temperature while maintaining their temperature difference constant and equal to said initial difference; and means for calculating said thermal property of the samples from at least knowledge of said initial temperature difference, of the rate at which the temperature of said samples varies over time, and of the difference in the power delivered to or extracted from said samples by the corresponding means in order to maintain said temperature difference constant.
In a variant, said differential calorimeter measurement head may be a head for heat flux scanning differential calorimetry, and comprises: two receptacles having substantially identical thermal properties, for receiving said samples; means for delivering or extracting heat power to or from said samples; heater or cooling means for differentially heating or cooling said receptacles so as to impose said initial temperature difference between the samples; and measurement means for measuring the instantaneous temperature of said samples, their temperature difference, and a heat flux entering or leaving each sample; said control and analysis means comprising: control means for controlling said means for delivering or extracting heat power to or from the samples, and adapted to subject said samples to said temperature variation; and means for calculating said thermal property of the samples from at least knowledge of said heat exchange coefficient, of said initial temperature difference, of the rate at which the temperature of one of the samples varies, and of the instantaneous temperature difference between said samples.
The receptacles are thermally coupled to a thermal bath by the same known heat transfer coefficient, said thermal bath then being provided with means for delivering or extracting heat power in order to give rise to a variation over time in its temperature.

Other characteristics, details, and advantages of the invention appear on reading the following description made with reference to the accompanying drawings given by way of example and in which:

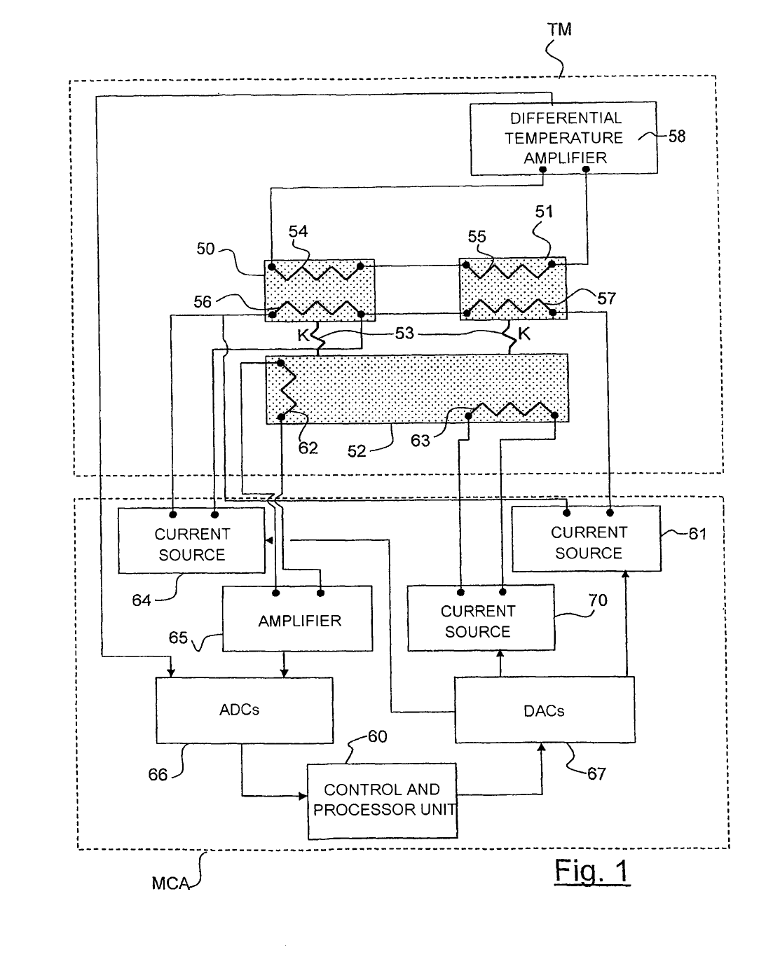

FIG. 1 is a simplified diagram of apparatus enabling the method of the invention to be implemented;

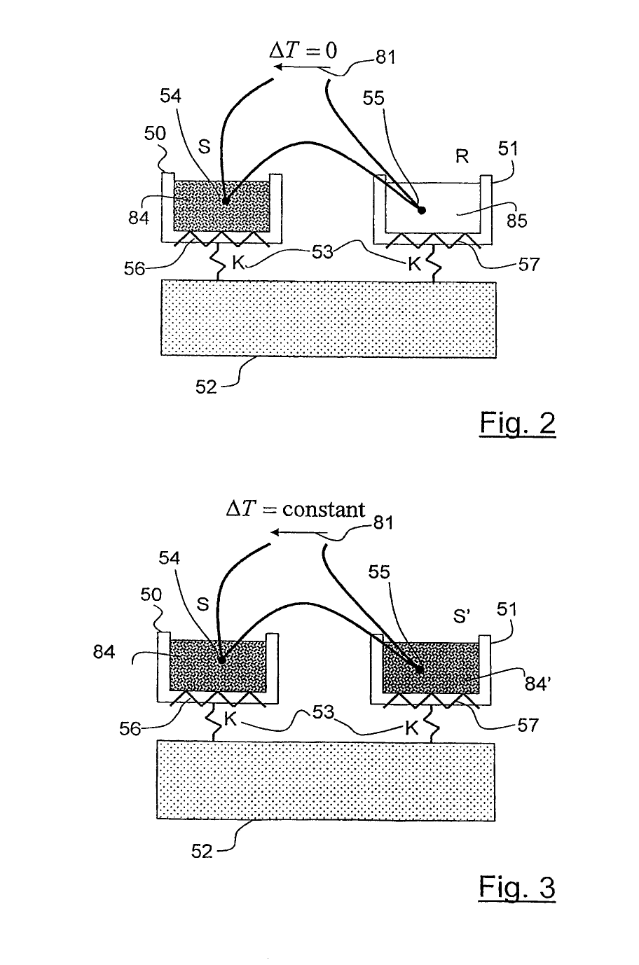

FIG. 2 is a very simplified diagram showing the usual operation of differential scanning calorimetry apparatus;

FIG. 3 is a very simplified diagram showing the operation of differential scanning calorimetry apparatus used for implementing a measurement method of the invention;

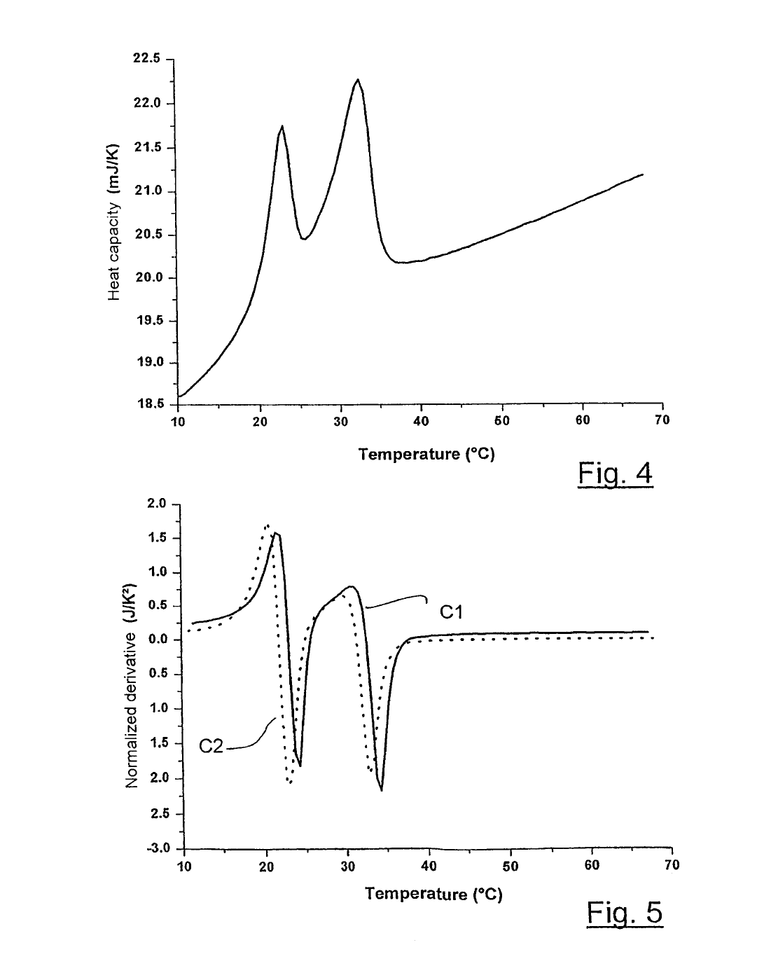

FIG. 4 is a graph plotting the curve of heat capacity as a function of temperature for a sample of a polymer, polytetrafluoroethylene (PTFE), measured in accordance with a prior art technique;

FIG. 5 is a graph showing the curve for the temperature derivative of the heat capacity as a function of temperature for the same sample, as obtained by differentiating the curve of FIG. 4 (continuous line) and as obtained by direct measurement in accordance with the invention (dashed line); and

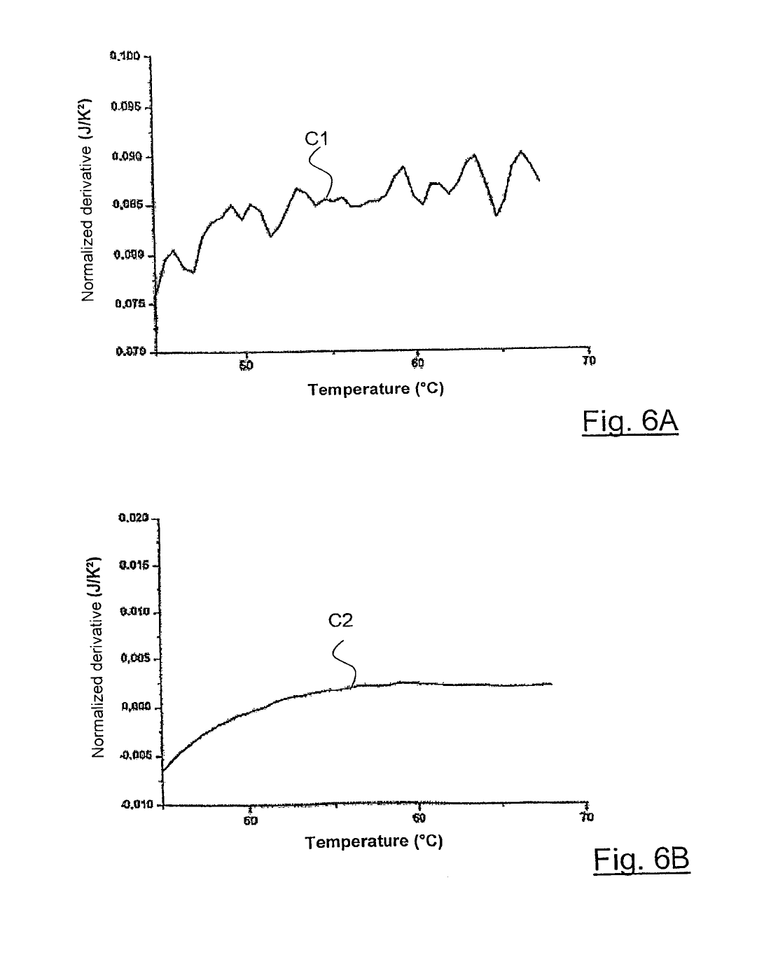

FIGS. 6A and 6B are graphs showing enlargements of the curves in FIG. 5, showing the advantages of the invention in terms of signal-to-noise ratio.

In the figures, elements that are identical or analogous are identified by the same reference numerals.

FIG. 1 shows differential calorimetry apparatus adapted to implementing the invention. Such apparatus essentially comprises a measurement head TM, which may be of conventional type (known in the prior art), and control and data analysis means MCA specially adapted to implementing the invention.

The measurement head TM has two measurement cells 50 and 51 that are thermally connected to a thermal bath 52 of heat capacity that may be considered as being infinite compared with that of each of the two cells 50 and 51. The thermal connection 53 between cell and the bath 52 is represented by a heat transfer coefficient K that is identical for both cells. This thermal connection takes place in different ways depending on the various calorimeter appliances that might be used (heat transfer gas, thermal conductance of a determined material, etc.). The two cells 50 and 51 are thermally isolated from each other, and they are substantially identical from a thermal point of view. Each cell includes a thermometer element 54 or 55 and a heater element 56 or 57 (in theory, a cooling element could equally well be used, but that is unusual). The thermometer element may operate on a variety of measurement principles: resistive thermometry, thermocouple thermometry, thermopile, etc. All of these techniques are commonly used in calorimetry. These thermometer elements 54 and 55 are connected in differential mode, e.g. using a Wheatstone bridge, so as to give the temperature difference between the two cells 50 and 51. This temperature difference is amplified by an amplifier 58, converted into a digital signal by an analog-to-digital converter 66, and then transferred to the control and data processor unit 60 for processing in real or deferred time.

The “absolute” temperature of one or both of the cells 50 and 51 may itself be measured, amplified, converted into digital format, and transferred to the control and processor unit 60 (not shown). This may be necessary for performing certain implementations of the invention, as explained below.

The heater (or cooling) elements 56 and 57 are controlled by the control and processor unit 60 via the digital-to-analog converter 67 and the current source 61, so as to deliver predetermined heat power to the two cells 50 and 51 (which power may be negative, should cooling elements be in use).

Establishing an initial temperature difference between the two cells (and also establishing power compensation, if any, if the apparatus is used in power compensated DSC mode), requires additional power to be delivered, which additional power may be provided by an independent current source 64, connected to one of the heater elements (the element 56 in this example).

The thermal bath 52 is also provided with a thermometer 62 (and an associated amplifier 65) and with a heater or cooling element (63), likewise under the control of the control and processor unit 60 via the digital-to-analog converter 67 and another current source 70. Generally, it is by means of this set of thermometer elements 62 and heater elements 63 that the temperature ramps or any other temperature variation are produced in the cells 50 and 51. Under such circumstances, the elements 56 and 57 act solely as differential heater or cooling means for establishing the initial temperature difference (and where applicable they also act as power compensation means).

In a variant, the heater elements 56 and 57 may be used directly for producing the temperature variations desired for the cells 50 and 51.

The measurement head TM may be subdivided into three different links. The acquisition link or differential measurement link comprises the two thermometers 54 and 55, the differential temperature measurement amplifier 58, and one or more acquisition cards included in the converter 66, or being connected to the control and processor unit 60. The temperature regulation link is servo-controlled to the differential measurement link, e.g. by a proportional integral differential (PID) control loop; it comprises the two heater elements 56 and 57, the current sources 61 and 64, and the digital-to-analog converter 67, together with the control and processor unit 60. The third link comprises a thermometer 62 with its own measurement system (amplifier 65, analog-to-digital converter 66, unit 60), and the heater element 63 with its control system connecting it to the unit 60 so as to control the temperature of the thermal bath 52.

The measurement head of the FIG. 1 apparatus is very general and may be used equally well for implementing the invention or for performing a measurement in accordance with a technique known in the prior art (simple differential temperature analysis when only the temperature difference is measured between the two cells; heat flux mode differential enthalpy measurement when the temperature difference is measured by means of a thermo-element such as a thermopile or a thermocouple; power compensated differential enthalpy measurement when the temperature difference between the cells 50 and 51—whatever measurement mode is used—is maintained equal to zero by using the two heaters 56 and 57; alternating calorimetry measurement when the heater elements 56 and 57 are used for delivering alternating power at a well-determined frequency, the difference between the oscillating temperatures being measured by the acquisition system constituted by the elements 58 and 60; temperature modulation differential calorimetry measurements in which, in addition to providing the temperature ramp, temperature is also caused to oscillate within the cells 50 and 51 via the bath 52, etc.).

FIG. 2 is a simplified diagram of power compensated differential scanning enthalpy measurements, in accordance with the prior art. A sample 84 having physicochemical properties that are to be measured is introduced into the cell 50, while the cell 51 is filled with a reference substance 85 that does not posses significant variation in the same physicochemical properties within the temperature range under consideration. Reference S designates the set constituted by the cell 50 and the sample 84, and reference R designates the set constituted by the cell 51 and the reference substance 85. The sets S an R present heat capacities that are substantially identical.

While performing the measurement, the temperature of the set S and the temperature of the set R both follow a temperature ramp that is imposed either by means of the bath 52 or directly by the two heater elements 56 and 57. The temperature difference between the sets S and R, written ΔT in FIG. 2, and represented diagrammatically by an arrow 81, is servo-controlled to the value zero during the ramp by means of the two heater elements 56 and 57. This temperature difference is measured by a thermocouple constituted by three conductors and two welds 54 and 55.

In power compensated differential scanning enthalpy analysis, the heat power difference absorbed by the reference 85 and by the sample 84, in particular as a result of the physicochemical changes to which the sample is subjected, is compensated instantaneously by means of the two heaters 56 and 57. This compensation differential heat power is measured directly by a system that is not shown in FIG. 2, e.g. using Joule's law, by measuring the instantaneous voltage at the terminals of the elements 56 or 57 and by measuring the compensation current conveyed by one or the other of the resistors during the experiment.

FIG. 3 is a simplified diagram of direct measurement of the derivative of the heat capacity of a sample relative to temperature, in accordance with an implementation of the invention. More precisely, this implementation of the invention is based on the principle of compensating power.

Unlike the method of FIG. 2, the cells 50 and 51 contain respective samples 84 and 84′ that are, in principle, identical. The sets constituted respectively by the cell 50 with the sample 84 and the cell 51 with the sample 84′ are written S and S′.

In addition, a determined temperature difference, written ΔT and represented diagrammatically by an arrow 81, is imposed between the two sets S, S′ and is servo-controlled to a constant value that is not zero by the heater elements 56 and 57. In a manner analogous to that which occurs in the method of FIG. 2, the difference in heat power absorbed by the two samples 84 and 84′ is compensated instantly by means of the two heaters 56 and 57. This compensation differential heat power, representative of the difference in power given off or absorbed by a sample 84 at a temperature T and a sample 84′ at a temperature T+ΔT is measured directly by a system that is not shown in FIG. 3; by way of example, this power may be determined by measuring the current conveyed by the resistors 56 and 57 and measuring the voltage across their terminals.

Unlike that which occurs in the prior art method, it is important to observe that the substances contained in both measurement cells 50 and 51 are subjected during the temperature ramp to physicochemical transformations that are the same, but at instants that are different.

According to the operating principle described with reference to FIG. 3, the present invention makes it possible to overcome certain problems that are usually encountered in conventional differential scanning calorimetry:
since, according to the invention, both cells are filled with the same substance having thermal properties that are to be studied, thermal asymmetries due to interface problems with the cells receiving a sample and a reference of a different nature are eliminated; and
the temperature derivatives of the signals usually measured in differential scanning calorimetry are obtained according to the invention with the same level of noise as the direct signals that are usually acquired with conventional differential methods. By integrating the derivative signal it is possible to restore the usual direct signals with a level of noise that is then greatly reduced (e.g. by a factor of 10) compared with that which can be obtained using prior art techniques.

There follows a mathematical description of the measurement principle in a non-limiting implementation of the invention.

Let T_{S} and C_{S} be the temperature and the heat capacity of the set S, let T_{S′} and C_{S′} be the temperature and the heat capacity of the set S′, let T_{B} be the temperature of the thermal bath, so ΔT=T_{S}−T_{S′}, and let K be the thermal coupling coefficient between each of the two sets S, S′ and the bath.

The temperatures of the two cells obey the general energy conservation law, which is described by a system of first-order linear differential equations that is written as follows:

$$\{ \begin{matrix}{P}_{S} - K ( {T}_{S} - {T}_{B} ) = {C}_{S} \frac{d {T}_{S}}{d t} \\ {P}_{{S}^{′}} - K ( {T}_{{S}^{′}} - {T}_{B} ) = {C}_{{S}^{′}} \frac{d {T}_{{S}^{′}}}{d t}\end{matrix} \qquad ( 1 )$$

in which P_{S} and P_{S′} are the powers delivered to the sets S and S′ by the heater elements 56 and 57, respectively.

By writing T_{S}=T_{S′}+ΔT, the following is obtained:

$$\{ \begin{matrix}{P}_{S} - K ( {T}_{{S}^{′}} + Δ T - {T}_{B} ) = {C}_{S} \frac{d {T}_{{S}^{′}}}{d t} + {C}_{S} \frac{d Δ T}{d t} \\ {P}_{{S}^{′}} - K ( {T}_{{S}^{′}} - {T}_{B} ) = {C}_{{S}^{′}} \frac{d {T}_{{S}^{′}}}{d t}\end{matrix} \qquad ( 2 )$$

By taking the difference between these two equations, and by writing ΔP=P_{S}−P_{S′} and ΔC=C_{S}−C_{S′}, the following is obtained:

$$Δ P - K \cdot Δ T = Δ C \frac{d {T}_{{S}^{′}}}{d t} + {C}_{S} \frac{d Δ T}{d t} \qquad ( 3 )$$

It is now assumed that the heater element 57 is controlled so as to give rise to a linear increase (a ramp) in the temperature of the set S′ with

$$\frac{d {T}_{{S}^{′}}}{d t} = β$$

constant, and that the temperature T_{S} is servo-controlled to track the same ramp by using the heater element 56, so as to maintain ΔT=ΔT₀ constant (and thus

$$\frac{d Δ T}{d t} = 0$$

).
This gives:

ΔP−K·ΔT_{( )}=ΔCβ (4)

Another simplification is obtained by subdividing the power difference ΔP into two terms: a constant term ΔP₀ that serves to establish the initial temperature difference ΔT₀, and that is exactly equal to KΔT₀, and a compensation term ΔP_{C} that enables ΔT=ΔT₀ to be maintained during the temperature ramp. This gives:

ΔP_{C}=ΔCβ (5)

At this point, it must be considered that the sets S and S′ are identical, except for their temperatures. The heat capacity difference ΔC is due entirely to this temperature difference and it may be written:

ΔC=C_{S}−C_{S′}=C_{S}(T_{S}+ΔT)−C_{S}(T_{S′}) (6)

By substituting (6) into (5) and dividing the right-hand and left-hand members by βΔT, the following is obtained:

$$\frac{Δ {P}_{C}}{βΔ T} = \frac{{C}_{S} ( T + Δ T ) - {C}_{S} ( T )}{Δ T} ≅ \frac{d {C}_{S}}{d T} {\vert}_{\overline{T}} \qquad ( 7 )$$

where the temperature index “S′” has been omitted and, where:

T̅=T+½(ΔT)=½(T_{S}+T_{S′})

Equation (7) shows that measuring the compensation differential heat power, for the constant temperature difference between the two sets and for the given rate of temperature variation makes it possible to determine the derivative of the capacities of the samples relative to temperature. During the ramp, T_{S} (and thus T̅) varies within a determined range. Consequently, equation (7) enables the derivative

$$\frac{d {C}_{S}}{d T} {\vert}_{\overline{T}}$$

to be calculated over the full extent of said range. The value of the heat capacity of the samples as a function of temperature C_{S}(T) can thus be obtained merely by numerical integration; the integration constant may be determined, if necessary, by an independent calorimetry measurement.

Equation (7) enables

$$\frac{d {C}_{S}}{d T} {\vert}_{\overline{T}}$$

to be determined only approximately. In principle, the approximation (and thus temperature resolution) improves with decreasing ΔT; however the ratio of the signal (ΔP_{C}) to the measurement noise improves with increasing ΔT. It is therefore necessary to find the best compromise between these two contradictory requirements. Equation (7) shows that the measured signal (ΔP_{C}) increases with increasing rate of temperature rise (i.e. with increasing β); however a ramp that is too fast also has effects that are adverse in terms of the temperature resolution of the measurement, since the thermal time constant of the calorimeter then needs to be taken into account; it would then be necessary to deconvolve the signal so as to take this time constant into account. It is therefore necessary to optimize the parameters ΔT and β as a function of the properties of the sample to be studied.

By way of example, consideration may be given to a material that presents two sudden variations of heat capacity at temperatures that are close together, being associated with two phase transitions. These variations are revealed by two close-together peaks of the derivative

$$\frac{d {C}_{S}}{d T}$$

and thus of the compensation differential thermal heat power ΔP_{C}. Under such conditions, and in principle, there will be a signal that is of relatively large magnitude, but it is necessary to take a measurement with good temperature resolution in order to be able to separate the two peaks. It is thus preferable to use relatively small values of ΔT and β for the measurement. For example, it is preferable for ΔT not to exceed one-tenth of the separation between the peaks, or of the width of each peak. In contrast, for a sample that presents variation in its heat capacity that is slow and regular, it is possible to sacrifice temperature resolution in order to improve the signal-to-noise ratio.

In general, an indicative criterion is that ΔT should generally not exceed one-tenth or one-hundredth of the amplitude of the range of temperature values in which the measurement is performed (i.e. the range of temperature values that are scanned by the ramp).

A measurement in accordance with the invention may also be performed in heat flux mode, without power compensation. When performing such a measurement, the temperature of the sample 84′ may be servo-controlled to track a linear increase (a ramp) resulting from variation in the temperature of the thermal bath. Under such conditions, the temperature difference between the two samples does not remain constant. It is possible to write ΔT(t)=ΔT₀+δT(t). Measuring this temperature difference makes it possible to determine the derivative of the heat capacity of the sample relative to temperature.

To understand that, it is possible to start from above equation (3). Unlike power compensation mode, the power difference ΔP is kept constant and equal to KΔT₀:

$$- K \cdot δ T = Δ C \frac{d {T}_{{S}^{′}}}{\underbrace{d t}_{= β}} + {C}_{S} \frac{d Δ T}{\underbrace{d t}_{= \frac{d δ T}{d t}}} \qquad ( 8 )$$

i.e.:

$$Δ C = - \frac{K \cdot δ T}{β} - \frac{{C}_{S}}{β} \frac{d δ T}{d t} \qquad ( 9 )$$

If the temperature rise is not too fast, and if the temperature difference δT(t) varies relatively slowly compared with the time constant of the calorimeter, it is possible to simplify equation (9) by ignoring the term

$$\frac{{C}_{S}}{β} \frac{d δ T}{d t} .$$

By dividing the left-hand and right-hand members by ΔT=ΔT₀+δT and by replacing ΔC with C_{S}(T+ΔT)−C_{S}(T), the following is obtained:

$$- \frac{K \cdot δ T}{β ( Δ {T}_{0} + δ T )} = \frac{{C}_{S} ( T + Δ T ) - {C}_{S} ( T )}{Δ T} ≅ \frac{d {C}_{S}}{d T} {\vert}_{\overline{T}} \qquad ( 10 )$$

The remarks made above concerning the optimum values for the parameters β and ΔT in the power compensation method apply likewise in this implementation of the invention.

Since in the method of the invention the measurement cells 50 and 51 contain substances that are substantially identical, it can be expected that the thermal asymmetries associated with interface problems will be eliminated compared with prior art methods. Nevertheless, other thermal asymmetries arising from the way in which calorimeters are made are never completely absent: that is why it can be appropriate to determine a “base line”, as in prior art methods, which base line is to be subtracted from the measurement results. The base line is determined by performing a measurement in accordance with the invention; put simply, the “sample” used is a “neutral substance” that does not present any change of state in the measurement temperature range and that has heat capacity that is relatively constant throughout the range.

Nevertheless, it should be observed that this step of determining and subtracting the base line is much less important than in the prior art. The error that results from the asymmetry generally does not exceed a few percent (10⁻²) of the value of

$$\frac{d {C}_{S}}{d T} .$$

When C_{S}(T) is calculated by integrating its derivative as obtained by performing a measurement in accordance with the invention,

$${C}_{S} ( T ) = {C}_{S}^{0} + {\int }_{{T}_{1}}^{{T}_{2}} ( \frac{d {C}_{S}}{d T} ) d T ,$$

the integration constant C_{S}⁰ is clearly preponderant, and the integral contributes only a few percent or a few parts per thousand (10⁻², 10⁻³). The error due to asymmetry affecting the measurement of

$$\frac{d {C}_{S}}{d T}$$

therefore represents, in all, only 10⁻⁴ to 10⁻⁵ of the heat capacity. In contrast, in the prior art, the asymmetry error affects the heat capacity measurement directly and is of the order of several percent thereof.

The theory on which the invention is based is described above in detail in the context of a temperature ramp that is linear, in which

$$\frac{d {T}_{{S}^{′}}}{d t} = β$$

for constant β. In reality, it is possible to use non-linear time variation of temperature, providing it is possible to approximate it with piecewise linear variation so as to be able to define the value of β locally. In particular, it is entirely possible to implement the method of the invention with “alternating” calorimetry, in which sinusoidal temperature variation is superposed on a ramp that is linear or quasi-linear.

The notion of piecewise linear variation also covers the situation in which, for a certain period, the temperature of one of the samples or both of them remains constant in spite of heat power being delivered thereto. This situation occurs, for example, in the presence of a first-order phase transition. Under such conditions, the notion of heat capacity temporarily ceases to have meaning, and needs to be replaced by the concept of latent heat, however the method of the invention nevertheless enables a “thermal event” to be revealed that provides information about the physical properties of the samples. The same situation also occurs in known techniques of the prior art.

FIG. 4 shows the curve of heat capacity of a sample of polytetrafluoroethylene as a function of temperature over the range 10° C. to 70° C. This curve was measured using a microcalorimeter fabricated in the inventor's laboratory and operating on the principle of temperature oscillation. The sample used was a disk of a thin film of polytetrafluoroethylene having a thickness of 50 micrometers (μm) and an area of 1 square centimeters (cm²) (giving a mass equal to about 5 milligrams (mg)). The temperature of the sample was varied over time using a ramp of 0.5 degrees celsius per minute (° C./min), having superposed thereon sinusoidal oscillation with a peak-to-peak amplitude of 0.1° C. and a frequency of 0.32 hertz (Hz). In the figure, there can be seen the two phase transitions that are characteristic of PTFE at 292 K and at 303 K: see the article by E. Château, J.-L. Garden, O. Bourgeois, and J. Chaussy, Appl. Phys. Lett. 86, 151913 (2005).

FIG. 5 shows the derivative as a function of temperature of the heat capacity of the above-described PTFE sample, after being normalized (taking account of preamplifier gains, thermometer calibrations, etc.). Continuous line curve C1 represents the numerical derivative calculated from the experimental points of FIG. 4. Dotted curve C2 represents the direct measurement of the derivative obtained by performing the differential measurement of the invention, for ΔT₀=1.3° C. The temperature offset between the two curves is an artifact that can be corrected. The method of the invention provides the value for the derivative of the heat capacity as a function of a mean temperature T̅, as explained above. The vertical offset visible in the figure could be eliminated merely by better calibration of the electronic systems used in the two types of experiment (in accordance with the invention and by direct measurement of C(T)), and also by better calibration of the various thermometers used.

On comparing magnifications of the curves C1 and C2, as shown in FIGS. 6A and 6B, it can be seen that the invention achieves a reduction in noise level.

In the description above, it is assumed that the samples are located inside closed cells. That is not always necessary: commercially-available calorimeters that are suitable for being adapted to implementing the invention only have supports that are similar to the trays of a balance, incorporating thermometer and heater elements and on which the samples are merely placed, possibly enclosed in capsules. More generally, any kind of receptacle can be suitable for providing measurement cells for performing the invention.

The implementation of the invention based on the power compensation principle is described above on the basis of an example in which the variation in the temperature of the samples is obtained directly by means of individual heater or cooling elements associated with each cell. Conversely, the implementation without power compensation is described with reference to an example in which the temperature of the samples is varied by means of a thermal bath. It should be understood that these examples are not limiting: whatever the measurement technique used, the variation in temperature may be controlled either directly, or by means of a thermal bath, or by a combination of both methods. This is already known in the prior art.

1. A thermal analysis method for determining a thermal property of a sample, the method comprising differentially measuring a physical parameter between two samples that are subjected to temperature variation under equivalent conditions, wherein said samples are substantially identical as to their composition and as to their thermal properties, and, at the beginning of measurement, they present an initial temperature difference of known magnitude.

2. The thermal analysis method according to claim 1, wherein the differential measurement serves to determine a thermal property of a sample selected from: the heat capacity of the samples, its derivative relative to temperature, or a latent heat.

3. The method according to claim 2, wherein the measurement is performed by differential temperature analysis, the method comprising:
measuring variation over time in the temperature difference between said samples; and
determining said thermal property from said variation over time of their temperature difference.

4. The method according to claim 2, wherein the measurement is performed by power compensation differential scanning enthalpy measurement, said method comprising:
delivering or extracting differential heat power to or from said samples in order to maintain said temperature difference constant throughout the measurement; and
determining said thermal property from said differential heat power.

5. A method according to claim 2, wherein the measurement is performed by heat flux scanning differential enthalpy measurement, and comprises:
coupling said samples to a thermal bath using the same known heat transfer coefficient;
measuring variation over time in the difference between the heat fluxes that flow between each of the samples and said thermal bath; and
determining said thermal property from said variation over time in the difference between the heat fluxes.

6. The method according to claim 1, wherein said variation over time in the temperature to which the samples are subjected is itself obtained, at least in part, by coupling said samples to a thermal bath that is in turn subjected to temperature variation over time.

7. The method according to claim 1, wherein said variation over time in the temperature to which the samples are subjected is itself obtained, at least in part, by individual heater or cooling means associated with each sample.

8. The method according to claim 2, further comprising numerically integrating the result of said differential measurement in order to determine the heat capacities of said samples in the temperature range within which said measurement was performed.

9. The method according to claim 1, wherein the variation over time in the temperature to which said samples are subjected is substantially linear or piecewise linear.

10. The method according to claim 1, wherein the initial temperature difference between said samples is less than or equal to one-tenth, of the extent of the temperature variation range over which the measurement is performed.

11. A thermal analysis apparatus comprising a differential calorimeter measurement head and control means for controlling said measurement head and for analyzing data obtained by the measurement, the control means being adapted to implement a method according to any preceding claim.

12. A thermal analysis apparatus according to claim 11, wherein said differential calorimeter measurement head is a head for performing differential thermal analysis, and comprises:
two receptacles having substantially identical thermal properties, for receiving said samples;
means for delivering or extracting heat power to or from said samples;
heater or cooling means for differentially heating or cooling said samples so as to impose said initial temperature difference; and
measurement means for measuring the instantaneous temperature difference between said samples and for measuring the rate at which the temperature of at least one of said samples varies over time;
said control and analysis means (MCA) comprising:
control means for controlling said means for delivering or extracting heat power to or from the samples, and adapted to subject said samples to said temperature variation; and
means for calculating said thermal property of the samples from at least knowledge of said initial temperature difference, of the rate at which the temperature of one of the samples varies, and of the instantaneous temperature difference between said samples.

13. The thermal analysis apparatus according to claim 11, wherein said differential calorimeter measurement head is a head for power compensated differential scanning calorimetry, and comprises:
two receptacles having substantially identical thermal properties, for receiving said samples;
means for delivering or extracting heat power to or from said samples; and
measurement means for measuring the instantaneous temperature of said samples and their temperature difference;
said control and analysis means comprising:
control means for controlling said means for delivering or extracting heat power to or from the samples, said control means being adapted to subject said samples to said variation over time of temperature while maintaining their temperature difference constant and equal to said initial difference; and
means for calculating said thermal property of the samples from at least knowledge of said initial temperature difference, of the rate at which the temperature of said samples varies over time, and of the difference in the power delivered to or extracted from said samples by the corresponding means in order to maintain said temperature difference constant.

14. The thermal analysis apparatus according to claim 11, wherein said differential calorimeter measurement head is a head for heat flux differential scanning calorimetry, and comprises:
two receptacles having substantially identical thermal properties, for receiving said samples;
means for delivering or extracting heat power to or from said samples;
heater or cooling means for differentially heating or cooling said receptacles so as to impose said initial temperature difference between the samples; and
measurement means for measuring the instantaneous temperature of said samples, their temperature difference, and a heat flux entering or leaving each sample;
said control and analysis means comprising:
control means for controlling said means for delivering or extracting heat power to or from the samples, and adapted to subject said samples to said temperature variation; and
means for calculating said thermal property of the samples from at least knowledge of said heat exchange coefficient, of said initial temperature difference, of the rate at which the temperature of one of the samples varies, and of the instantaneous temperature difference between said samples.

15. The thermal analysis apparatus according to claim 11, wherein said receptacles are thermally coupled to a thermal bath by the same known heat transfer coefficient, said thermal bath being provided with means for delivering or extracting heat power in order to give rise to a variation over time in its temperature.
